(19) United States
(12) Patent Application Publication
(10) Pub. No.: US 2004/0141805 A1
(43) Pub. Date: Jul. 22, 2004

(54) Waist connection apparatus for an artificial model

(76) Inventor: Jung-Chang Chiang, Taipei (TW)

Correspondence Address: PRO-TECHTOR INTERNATIONAL, 20775 Norada Court, Saratoga, CA, 95070-3018, US

(21) Appl. No.: 10/346,764

(22) Filed: Jan. 16, 2003

(51) Int. Cl. B25G 3/00

(52) U.S. Cl. 403/353

(57) ABSTRACT

A waist connection apparatus for an artificial model comprises an upper and a lower bases respectively, and an upper and a lower engaging disks respectively. The upper and the lower engaging disks are fastened to the upper and the lower bases respectively. The upper and the lower disks provide detachable connecting parts such that the upper and the lower parts of the model can be joined together or separated apart easily. Hence, the waist connection apparatus makes the model possible to be hung up, lean to one side, and many other postures as desired by the need of exhibition. Furthermore, the waist connection apparatus can fit any size of the model as soon as a proper sized waist connection apparatus is replaced.

### BACKGROUND OF THE INVENTION

1. Field of the Invention

The present invention relates to a waist connection apparatus for an artificial model, and, particularly, to a connection apparatus, which is possible to detachably connect the waist part of an artificial model with an upper and a lower halves easily.

2. Description of Related Art

For a clothes maker, the artificial model is an indispensable tool for a fashion exhibition. The artificial model allows a variety of clothes to be presented a real state of being put on in a best way to attract the customers during shopping. Hence, it is very important to the clothes maker whether the model is good or not.

Now we will take a closer look at some conventional model as shown in FIG. 11. The upper part of lower half 42 of the display model 40 contains a central pole 4202. The upper half 41 of the display model 40 has got a hollow part 4101 opposite to the central pole 4202 able to take in this said central pole 4202. This kind of construction is admittedly fast and simple to join together. But, if you take a closer look at FIG. 12, you will see that in case of a bend body position, with the center of weight not exactly on the position of the pole, there appears a small gap 43 between the upper half 41 and the lower half 42 of the display model 40. This shows the present construction does not represent an ideal solution for the hanging of a display model due to insufficient precision.

We also took a closer look at another construction for a waist connection apparatus for an artificial model. This construction makes use of a spring bolt in the center of the waist plate of the display model. This construction reaches the target of creating a fixed connection between the upper and the lower half of a display model, but it is unable to control the insertion strength, furthermore, the force needed to join the parts of the display model together or take it apart is too high (Because it need to overcome the elasticity of the spring). Therefore you need different types of display models for each different body posture. Otherwise the display model could easily take damage through the gap 43 which appears between the upper half 41 and the lower half 42 of the display model 40 (as shown in FIG. 12). With the connecting mechanism damaged or not functional, the upper as well as the lower half of the artificial model have to be repaired. This does not meet the practical or economic requirements of these artificial models.

Another type of waist connection apparatus for an artificial model to be compared is the Chinese patent No. CN 2401097Y, which makes use of a structure based on a round main plate. One side of the main plate consists of an inserting structure, and the other side is used as a securing structure. This model clearly has the advantage of being easy to install and take apart, but there is still a strong insertion force to overcome. Using this model, it is still not possible to solve the problems of hanging artificial models or of the control of the insertion strength. As shown in FIG. 13, that a hanging display model 40 can not provide a perfect balance of weight, because the positions of the arms and legs on the left and right side are not the same. This again can easily result in a gap 43 between the upper half 41 and the lower half 42 of the artificial model 40.

### SUMMARY OF THE INVENTION

The main object of the present invention is to provide a waist connection apparatus for an artificial model, which has an exact, easy to use and secure mounting and possesses the possibility to secure it in two different directions.

The second object of the present invention is to provide a waist connection apparatus for an artificial model, which can be used as a hanging or mounted structure, and which offers an easy and close connection of waist area without leaving a gap.

A further object of the present invention is to provide a waist connection apparatus for an artificial model, which makes use of two symmetrical main plates, one upper and one lower main plate, with more than one pair of facing screw holes at the left and right of the center, which causes the center of the upper and lower main plate to be in exact correspondence.

Another object of the present invention is to provide a waist connection apparatus for an artificial model, which is standardized in its construction, resulting in freely exchangeable upper and lower parts of the display models, a main factor for the economic use of the artificial model.

Furthermore it is a object of the present invention to provide a waist connection apparatus for an artificial model, which can be separated into different parts. In case of a damaged part you can take apart the display model and repair the damaged part only, without the need to repair or replace the complete unit. This factor also is important for the economic and practical use of the artificial model.

### BRIEF DESCRIPTION OF THE DRAWINGS

The other objects and features of the present invention can be more fully understood by reference to the following description of preferred embodiments and accompanying drawing, in which:

FIG. 1 is a perspective view of a waist connection apparatus for an artificial model according to the present invention;

FIG. 2 is the full view of the attachment of the parts covered by the present invention to the artificial model.

FIG. 3 is a detailed display of the connecting parts of the present invention attached to the artificial model.

FIG. 4 is a practical example for the better form of the securing plates in the present invention.

FIG. 4A is the cross-section of the part labeled A-A shown in FIG. 4.

FIG. 5 is another practical example for the better form of the securing plates in the present invention.

FIG. 5A is the cross-section of the part labeled B-B in FIG. 5.

FIG. 6A is a detailed display for the fastening of the securing plates on the slit openings in the present invention through the use of screws.

FIG. 6B is a detailed display for the securing mode of the securing bodies in the present invention.

FIG. 7 is the lower view of the upper main mounting in the present invention.

FIG. 8 is a three-dimensional display of the upper main mounting and the mounting seat in the present invention.

FIG. 9 is a cross-section display of the mounted seat in the present invention.

FIG. 10 is a display of the present invention in use on an upside-down display model.

FIG. 11 is a display of the structure of a conventional, standing artificial model, used for reference and comparison.

FIG. 12 is a display of the structure of a conventional, seated artificial model, used for reference and comparison.

FIG. 13 is a display of the structure of a conventional, hanging artificial model, used for reference and comparison.

### DETAILED DESCRIPTION OF THE PREFERRED EMBODIMENTS

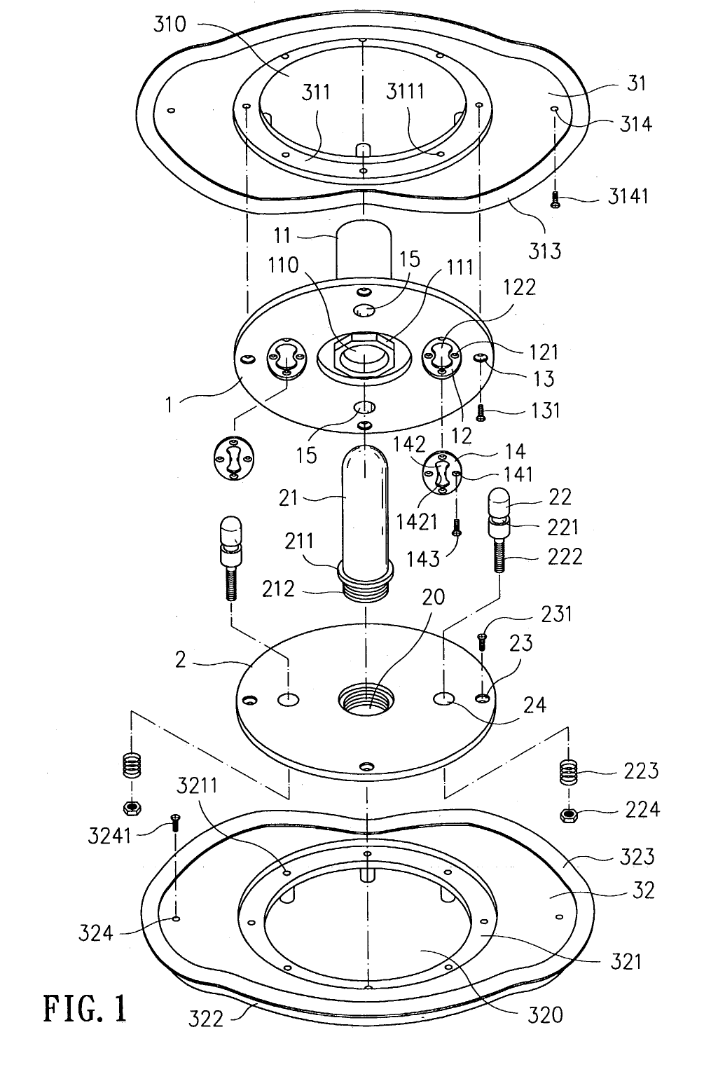

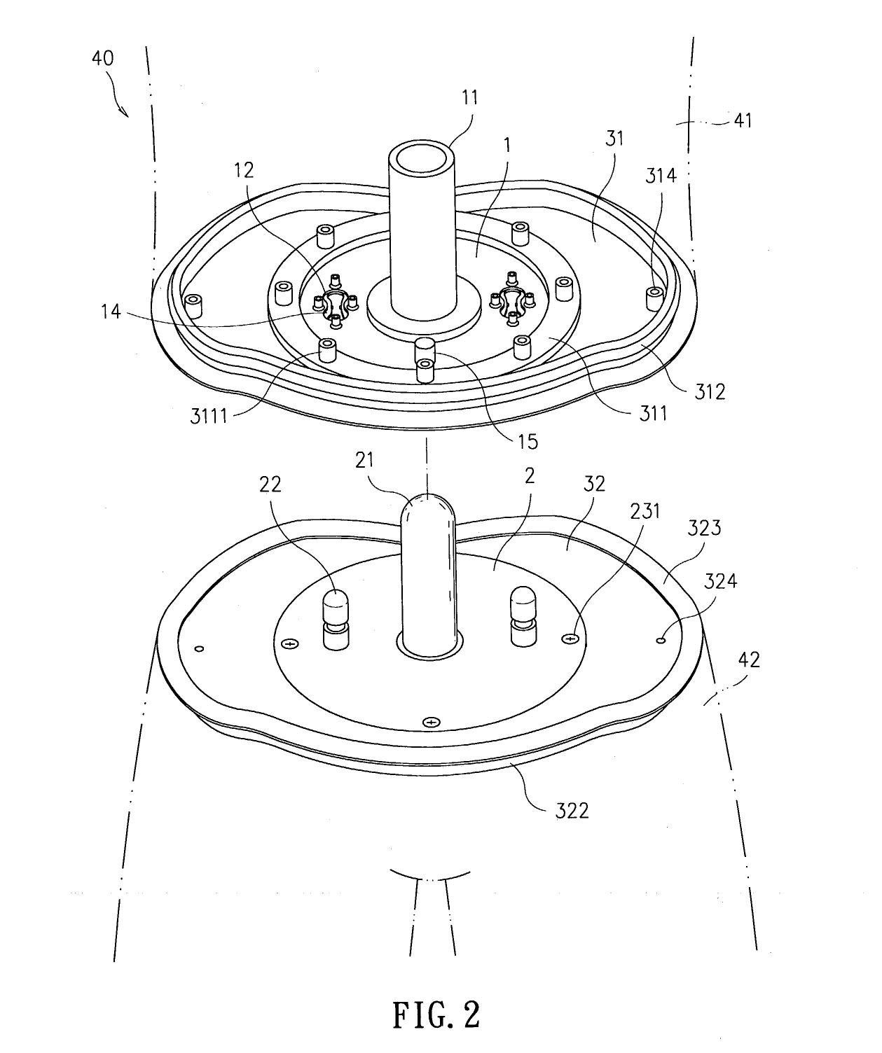

Referring to FIG. 1 to FIG. 3, which describe the structure of the present invention, a waist connection apparatus for an artificial model. The parts described therein are as follows:

An upper main plate 31, which is secured with screws 3141 through the screw holes 314 on the lower side of the upper half 41 of the display model 40. The middle of this main plate consists of a round socket 311. All around the edge of this socket 311, there are several screw holes 3111; the center of this socket 311 consists of the hole 310 for the main mounting;

A lower main plate 32, which is secured with screws 3241 through the screw holes 324 on the upper side of the lower half 42 of the display model 40. The middle of this main plate consists of a round socket 321. All around the edge of this socket 321, there are several screw holes 3211, the center of this socket 321 consists of the hole 320 for the main mounting;

An upper main mounting 1, which is secured with screws 131 through the screw holes 13 on the above mentioned socket 311 of the upper main plate 31. The middle of this upper main mounting 1 consists of a fixed, hollow body 11, opened up to the lower side by a connecting opening 110. On the lower part of the upper main mounting 1, there is a protruding polygon base 111 as well as two small sleeves 15, located in front of and behind the fixed, hollow body 11. To the left and right sides of the fixed, hollow body 11, there are two slit openings 12. Insides of these slit openings 12 there are securing plates 14 inserted. The part which consists of the slit openings 12 and the securing plates 14 has a full opening 122, a securing hole 142 and screw holes 121, 141. Screws 143 secure the construction through the screw holes 121, 141. By this process, the securing plates 14 are being attached to the slit openings 12.

A lower main mounting 2, which is secured with screws 231 through the screw holes 23 on the above mentioned socket 321 of the lower main plate 32. This lower main mounting 2 possesses a large central screw hole 20. Mounted in this central screw hole 20 is a control pole 21, facing upwards. The lower end of the control pole 21 consists of a screw thread 212, which is used to secure it in the central screw hole 20. On the lower main mounting 2 there are two securing bodies 22 facing the securing holes 14 of the upper main mounting 1.

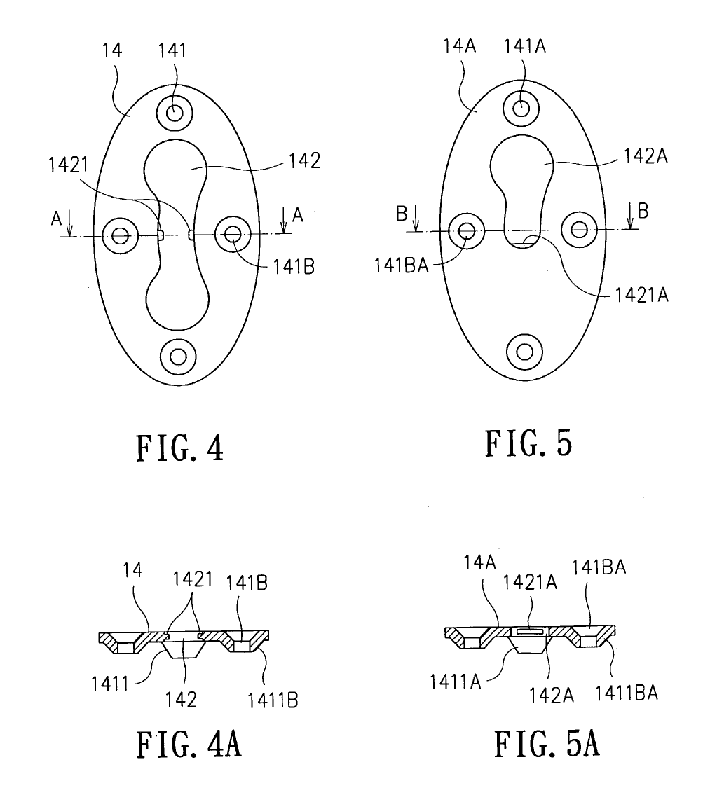

Referring to FIG. 4 and FIG. 4A, the relatively large openings of the securing holes 142 describe a form roughly resembling an “8”. In the connecting part between the hole with the larger diameter and the hole with the smaller diameter, there is a thin strip 1421, which solves the purpose of helping to insert the insertion slit 221 of the securing bodies 22 into the securing hole 142. Referring to FIG. 5 and FIG. 5A, that the securing hole 142A roughly resembles the form of a calabash, also with a thin strip 1421A attached. The difference between the structures described in FIG. 4 and FIG. 5 is, that the structure described in FIG. 4 uses two-way securing holes 142 which give the securing bodies 22 two possible directions of attachment, while the structure described in FIG. 5 uses one-way securing holes 142A which give the securing bodies 22 only one possible direction of attachment. Both structures can be exchanged depending on the practical usage.

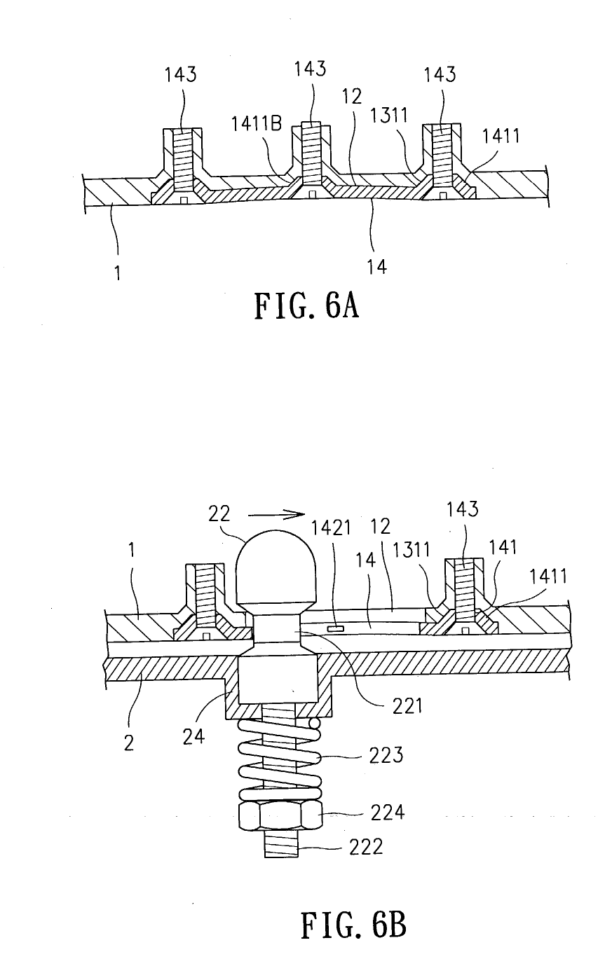

FIG. 6A and FIG. 6B show that the securing plates 14 are attached to the upper main mounting 1 through screw holes 141, 141B. There are also protruding conical forms 1411, 1411B to be seen, which stick out of the main mounting in upward direction. On the upper main mounting 1 there are indent forms 1311 which correspond with the protruding conical forms 1411 and which are able to take them in. Through the use of these, fine tunings to the force of the securing plates 14 can be done. The protruding conical forms 1411 on the vertical axis of the securing plate are higher than the protruding conical forms 1411B on the horizontal axis of the securing plates. As you can see in the picture, this gives you the ability to determine how deep the securing plates 14 will be drawn into the slit openings 12 of the upper main mounting 1.

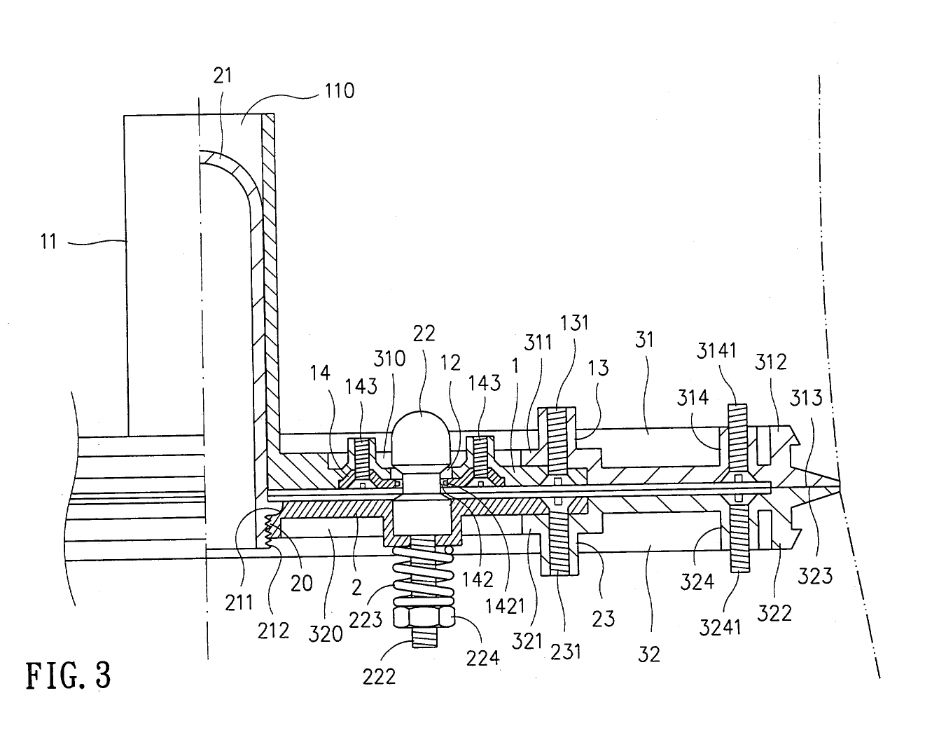

The upper main plate 31 and the lower main plate 32 each have got eight screw holes 3111, 3211 ordered in exact the same direction and distance. While joining the upper half 41 and the lower half 42 of the display model 40 together, the upper main mounting 1 and the lower main mounting 2 can be used to adjust the upper half 41 and the lower half 42 of the display model 40 to one of the eight possible directions. The control pole 21 will be inserted into the fixed, hollow body 11. As shown in FIG. 3, the lower main mounting 2 possesses a central screw hole. On the point of contact between the screw hole and the control pole 21, there is a slight widening 211 or a conical bevel, which is used for a better and more secure connection. The two securing bodies 22 on the lower main mounting 2 can be inserted into the securing holes 142 of the securing plates 14.

Please view FIG. 4 to FIG. 6B. On the lower end of the securing bodies 22 there is a screw bolt 222, which sticks through the insertion slit 24 of the lower main mounting 2. Just outside of the insertion slit 24 a spring 223 is wrapped around the screw bolt 222. The end of the construction is secured by a nut 224. This construction can be used to make fine tunings to the height and force of the securing bodies 22. While the securing plates 14 are mounted on the slit openings 12 of the upper main mounting 1, they are pushed to the inside. The advantage of this kind of construction is, that the securing bodies 22 upon entering the securing holes 142 and being turned slightly are being locked on the thin strip 1421. This thin strip 1421 locks the securing bodies in and holds them tight. Through this, a securing effect is reached. The securing bodies 142 will not be able to move anymore.

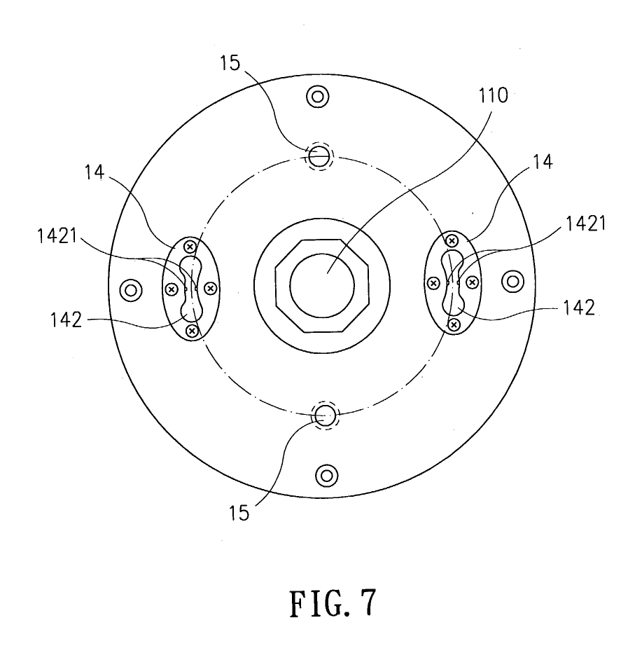

Referring to FIG. 1 and FIG. 7, the securing holes 142 of the securing plates 14 and the small sleeves 15 surround the connecting opening 110 of the upper main mounting 1 in a circle, each with exact the same distance to the center. To use the numbers of the clock face to describe it, the two securing plates 14 are located on the positions 3 o'clock and 9 o'clock, while the two small sleeves 15 are located on the positions 6 o'clock and 12 o'clock. After inserting the control pole 21 into the connecting opening 110, the securing bodies 22 can be locked in the securing holes 142 through a slight turning movement. Furthermore, you have the option to insert the securing bodies 22 into the small sleeves 15, thus joining the upper and lower half of the artificial model without using the securing function of the securing plates 14. This method provides a fast and convenient way to join artificial models together, which afterwards shall be used in upright positions.

Besides of this we can see in FIG. 3 that the outer rim of the upper main plate 31 and the lower main plate 32 is formed of a thin, protruding edge 313, 323. This allows a small gap between the upper main plate 31 and the lower main plate 32. Furthermore it creates a smoother connection between the upper main plate 31 and the lower main plate 32. To improve the symmetry between the upper main plate 31 and the lower main plate 32, there are two fixed screw holes 314, 324 left and right of the center of each plate. The effect of these screw holes 314, 324 is to let the respective centers of the upper main plate 31 and the lower main plate 32 correspond exactly. By this means you can also use the upper and lower half of different display models together. The different models are thus freely interchangeable and do not have to be specifically adjusted to each other. This also furthers the economic use of the display model.

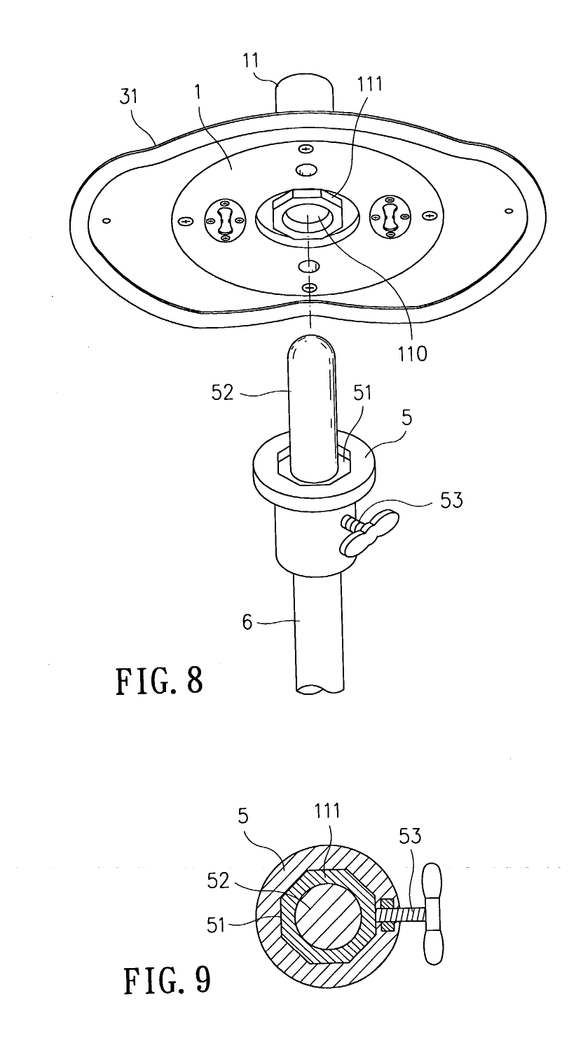

Now we want to take a further look at in FIG. 8 and FIG. 9. On the lower side of the upper main mounting 1, there is a protruding polygon base 111. This base can be used together with a height-adjustable mounting seat 5 which possesses an indent polygon form 51. This mounting seat 5 is fitted onto a central pole 6. On the upper end of the mounting seat 5 there is a control pole 52, which can be inserted into the connecting opening 110. Furthermore the mounting seat 5 possesses an adjusting screw 53. The height of the mounting seat 5 and the central pole 6 can be adjusted through use of the adjusting screw 53. Through inserting the control pole 52 into the hollow body 11 an ideal position of weight balance will be found. The protruding polygon base 111 corresponds with the indent polygon form 51. These two can be used to secure the position of the upper main mounting 1. This can also be used to bring the upper main mounting 1 into a different position.

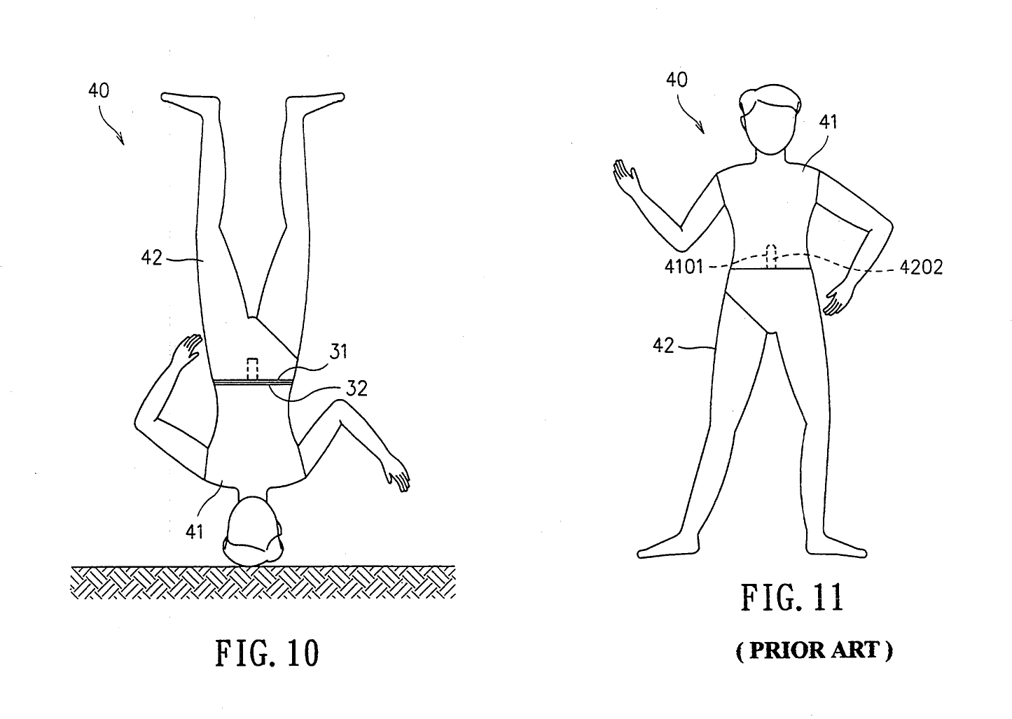

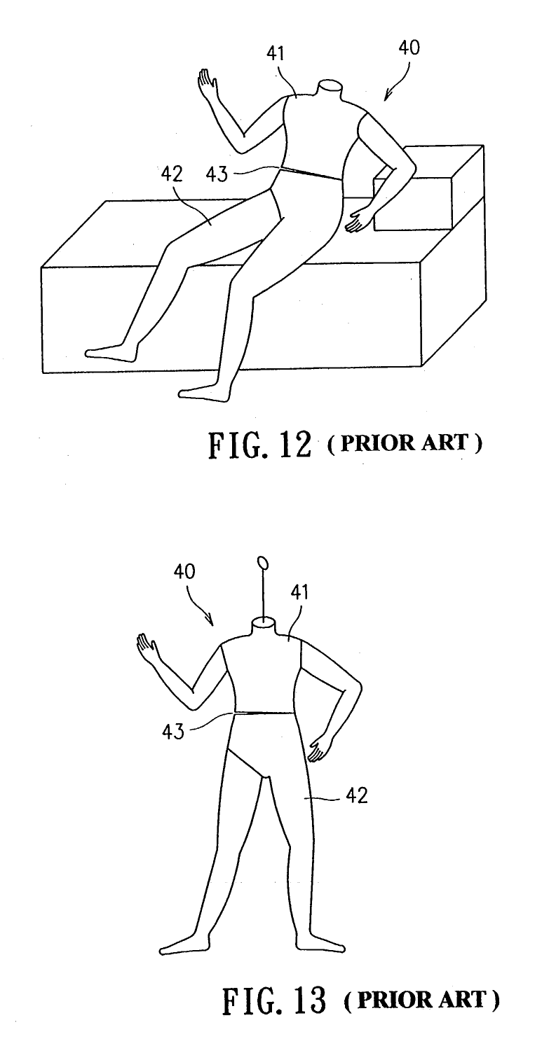

In FIG. 10 we see an example, how the upper main plate 31 and the lower main plate 32 can be attached to the lower half 42 and the upper half 41 of the artificial model 40. In this example, the construction can even be used with an upside-down artificial model 40.

While the invention has been described with reference to preferred embodiments thereof, it is to be understood that modifications or variations may be easily made without departing from the spirit of this invention, which is defined by the appended claims.

What is claimed is:

1. The waist connection apparatus for an artificial model, comprising:
an upper main plate, which is fixed to the lower part of the upper half of the display model. The middle of this main plate is formed by a socket with screw holes in it. The center of the socket is formed by a hole for the main mounting;
a lower main plate, which is fixed to the upper part of the lower half of the display model. The middle of this main plate is formed by a socket with screw holes in it. The center of the socket is formed by a hole for the main mounting;
an upper main mounting, which is secured in the socket of the above mentioned upper main plate. In the center of this main mounting is a fixed, hollow body with a connecting opening facing down. Left and right of the fixed, hollow body, there are two slit openings containing securing plates, which themselves contain securing holes;
a lower main mounting, which is secured in the socket of the above mentioned lower main plate. In the center of this main mounting is a central screw hole, into which a control pole is fitted. The lower main mounting has got two securing bodies facing the securing holes of the upper main mounting.
While joining the upper and lower halves of the display model together, the control pole is inserted into the fixed, hollow body, and the two securing bodies fit into the securing holes on the securing plates. Through a slight turning motion the insertion slit of securing bodies become locked in the securing holes.

2. The waist connection apparatus for an artificial model according to claim 1, wherein the securing bodies have a screw bolt on the lower end, which sticks through the insertion slit of the lower main mounting. Just outside of the insertion slit a spring is wrapped around the screw bolt. The end of the construction is secured by a nut. This construction can be used to make fine tunings to the height and force of the securing bodies.

3. The waist connection apparatus for an artificial model according to claim 1, wherein the securing holes of the securing plates and the small sleeves surround the center of the upper main mounting in a circle, each with exact the same distance to the center. To use the numbers of the clock face to describe it, the two securing plates are located on the positions 3 o'clock and 9 o'clock, while the two small sleeves are located on the positions 6 o'clock and 12 o'clock. After inserting the control pole into the connecting opening, the securing bodies can be locked in the securing holes with a slight turning movement. Alternatively, you have the option to insert the securing bodies into the small sleeves, thus joining the upper and lower half of the display model without using the securing function of the securing plates.

4. The waist connection apparatus for an artificial model according to claim 1, wherein the relatively large openings of the securing holes describe a form roughly resembling an “'8”.

5. The waist connection apparatus for an artificial model according to claim 1, wherein the point of contact between the screw hole and the control pole has a slight widening or a conical bevel, which is used for a better and more secure connection.

6. The waist connection apparatus for an artificial model according to claim 1, wherein the securing holes of the securing plates have a thin strip in the connecting part between the hole with the larger diameter and the hole with the smaller diameter, which solves the purpose of helping to insert the insertion slit of the securing bodies into the securing hole.

7. The waist connection apparatus for an artificial model according to claim 1, wherein the securing plates are attached to the upper main mounting through screw holes, which are formed of protruding conical forms, which stick out of the upper main mounting in upward direction. On the upper main mounting there are indent forms which correspond with the protruding conical forms and which are able to take them in. Through the use of these, fine tunings to the force of the securing plates can be done.

8. The waist connection apparatus for an artificial model according to claim 1, wherein the elliptic securing plates comprise four screw holes, two on the vertical and two on the horizontal axis. The protruding conical forms on the vertical axis of the securing plate are higher than the protruding conical forms on the horizontal axis of the securing plates.

9. The waist connection apparatus for an artificial model according to claim 1, wherein the outer rim of the upper main plate and the lower main plate is formed of a thin, protruding edge. This allows a small gap between the upper main plate and the lower main plate. Furthermore it creates a smoother connection between the upper main plate and the lower main plate.

10. The waist connection apparatus for an artificial model according to claim 1, wherein two fixed screw holes left and right of the center of each plate are used to improve the symmetry between the upper main plate and the lower main plate. The effect of these screw holes is to let the respective centers of the upper main plate and the lower main plate correspond exactly.

11. The waist connection apparatus for an artificial model according to claim 1, wherein the upper main plate and the lower main plate each have got eight screw holes ordered in exact the same direction and distance. These can be used to adjust the display model to one of the eight possible positions.

12. The waist connection apparatus for an artificial model according to claim 1, wherein the lower side of the upper main mounting has got a protruding polygon form that can be used together with a height-adjustable mounting seat, which possesses an indent polygon form. The protruding polygon form corresponds with the indent polygon form. These two can be used to secure the position of the upper main mounting. This can also be used to bring the upper main mounting into a different position or to adjust its height.
